(19) United States
(12) Patent Application Publication
(10) Pub. No.: US 2020/0151453 A1
(43) Pub. Date: May 14, 2020

(54) REDUCING OVERLAP AMONG A COLLECTION OF PHOTOGRAPHS

(71) Applicant: International Business Machines Corporation, Armonk, NY (US)

(72) Inventors: Yuk L. Chan, Rochester, NY (US); Heidi Lagares-Greenblatt, Jefferson Hills, PA (US); Deepti M. Naphade, Cupertino, CA (US)

(21) Appl. No.: 16/184,357

(22) Filed: Nov. 8, 2018

(51) Int. Cl. G06K 9/00; G06K 9/62; G06F 3/0481; G06F 17/30

(52) U.S. Cl. CPC G06K 9/00677; G06K 9/6215; G06K 9/00221; G06F 17/3028; G06F 3/0481

(57) ABSTRACT

An example computer-implemented method includes receiving a first plurality of images from a first user device and a second plurality of images from a second user device. The method further includes performing image processing on the first plurality of images and the second plurality of images. The method further includes comparing the first plurality of images to the second plurality of images based at least in part on the image processing to determine whether an overlap exists between at least one of the first plurality of images and at least one of the second plurality of images. The method further comprises creating a virtual container to group the at least one of the first plurality of images and the at least one of the second plurality of images.

### BACKGROUND

The present invention generally relates to image processing, and more specifically, to reducing overlap among a collection of photographs.

Digital photographs (also referred to as “images”) can be captured using devices such as digital cameras, cellular phones, smartphones, tablet computers, and the like. Users can share digital photographs using messaging applications, social media services, photograph sharing websites, and the like. For example, a user can publish photographs through a network such as a social network site. These photographs may be related to travel or other activities of the user and may be visible to other social network friends of the user or to other users. The friends or other users can provide comments, likes, feedback, etc. on the images. In some cases, a friend or other user might also have traveled to a particular place or partaken in a particular activity illustrated in an image, and the friend or another user may publish similar images of the places and/or activities in the social network site or otherwise share the images.

### SUMMARY

Embodiments of the present invention are directed to a computer-implemented method for reducing overlap among a collection of photographs. A non-limiting example of the computer-implemented method includes receiving, by a processing device, a first plurality of images from a first user device. The method further includes receiving, by the processing device, a second plurality of images from a second user device. The method further includes performing, by the processing device, image processing on the first plurality of images and the second plurality of images. The method further includes comparing, by the processing device, the first plurality of images to the second plurality of images based at least in part on the image processing to determine whether an overlap exists between at least one of the first plurality of images and at least one of the second plurality of images. The method further includes, responsive to determining that an overlap exists between the at least one of the first plurality of images and the at least one of the second plurality of images, creating, by the processing device, a virtual container to group the at least one of the first plurality of images and the at least one of the second plurality of images.

Embodiments of the present invention are directed to a system. A non-limiting example of the system includes a memory comprising computer readable instructions and a processing device for executing the computer readable instructions for performing a method for reducing overlap among a collection of photographs.

Embodiments of the invention are directed to a computer program product. A non-limiting example of the computer program product includes a computer readable storage medium having program instructions embodied therewith. The program instructions are executable by a processor to cause the processor to perform a method for reducing overlap among a collection of photographs.

Additional technical features and benefits are realized through the techniques of the present invention. Embodiments and aspects of the invention are described in detail herein and are considered a part of the claimed subject matter. For a better understanding, refer to the detailed description and to the drawings.

### BRIEF DESCRIPTION OF THE DRAWINGS

The specifics of the exclusive rights described herein are particularly pointed out and distinctly claimed in the claims at the conclusion of the specification. The foregoing and other features and advantages of the embodiments of the invention are apparent from the following detailed description taken in conjunction with the accompanying drawings in which:

FIG. 1 depicts a cloud computing environment according to one or more embodiments described herein;

FIG. 2 depicts abstraction model layers according to one or more embodiments described herein;

FIG. 3 depicts a block diagram of a processing system for implementing the presently described techniques according to one or more embodiments described herein;

FIG. 4 depicts a block diagram of a processing system for reducing overlap among a collection of images according to one or more embodiments described herein;

FIG. 5 depicts a block diagram of the processing system of FIG. 4 according to one or more embodiments described herein; and

FIG. 6 depicts a flow diagram of a method for reducing overlap among a collection of images according to one or more embodiments described herein.

The diagrams depicted herein are illustrative. There can be many variations to the diagram or the operations described therein without departing from the spirit of the invention. For instance, the actions can be performed in a differing order or actions can be added, deleted or modified. Also, the term “coupled” and variations thereof describes having a communications path between two elements and does not imply a direct connection between the elements with no intervening elements/connections between them. All of these variations are considered a part of the specification.

In the accompanying figures and following detailed description of the disclosed embodiments, the various elements illustrated in the figures are provided with two or three digit reference numbers. With minor exceptions, the leftmost digit(s) of each reference number correspond to the figure in which its element is first illustrated.

### DETAILED DESCRIPTION

Various embodiments of the invention are described herein with reference to the related drawings. Alternative embodiments of the invention can be devised without departing from the scope of this invention. Various connections and positional relationships (e.g., over, below, adjacent, etc.) are set forth between elements in the following description and in the drawings. These connections and/or positional relationships, unless specified otherwise, can be direct or indirect, and the present invention is not intended to be limiting in this respect. Accordingly, a coupling of entities can refer to either a direct or an indirect coupling, and a positional relationship between entities can be a direct or indirect positional relationship. Moreover, the various tasks and process steps described herein can be incorporated into a more comprehensive procedure or process having additional steps or functionality not described in detail herein.

The following definitions and abbreviations are to be used for the interpretation of the claims and the specification. As used herein, the terms “comprises,” “comprising,” “includes,” “including,” “has,” “having,” “contains” or “containing,” or any other variation thereof, are intended to cover a non-exclusive inclusion. For example, a composition, a mixture, process, method, article, or apparatus that comprises a list of elements is not necessarily limited to only those elements but can include other elements not expressly listed or inherent to such composition, mixture, process, method, article, or apparatus.

Additionally, the term “exemplary” is used herein to mean “serving as an example, instance or illustration.” Any embodiment or design described herein as “exemplary” is not necessarily to be construed as preferred or advantageous over other embodiments or designs. The terms “at least one” and “one or more” may be understood to include any integer number greater than or equal to one, i.e., one, two, three, four, etc. The terms “a plurality” may be understood to include any integer number greater than or equal to two, i.e., two, three, four, five, etc. The term “connection” may include both an indirect “connection” and a direct “connection”.

The terms “about”, “substantially”, “approximately”, and variations thereof, are intended to include the degree of error associated with measurement of the particular quantity based upon the equipment available at the time of filing the application. For example, “about” can include a range of ±8% or 5%, or 2% of a given value.

For the sake of brevity, conventional techniques related to making and using aspects of the invention may or may not be described in detail herein. In particular, various aspects of computing systems and specific computer programs to implement the various technical features described herein are well known. Accordingly, in the interest of brevity, many conventional implementation details are only mentioned briefly herein or are omitted entirely without providing the well-known system and/or process details.

It is to be understood that, although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

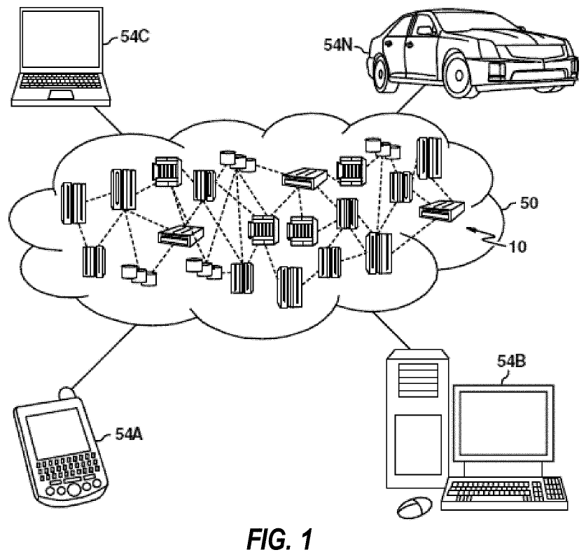

Referring now to FIG. 1, illustrative cloud computing environment 50 is depicted. As shown, cloud computing environment 50 includes one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 1 are intended to be illustrative only and that computing nodes 10 and cloud computing environment 50 can communicate with any type of computerized device over any type of network and/or network addressable connection (e.g., using a web browser).

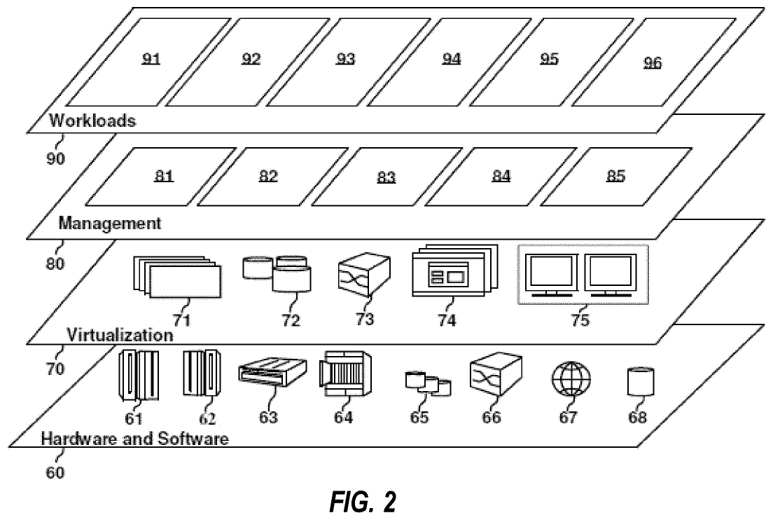

Referring now to FIG. 2, a set of functional abstraction layers provided by cloud computing environment 50 (FIG. 1) is shown. It should be understood in advance that the components, layers, and functions shown in FIG. 2 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and reducing overlap among a collection of photographs 96.

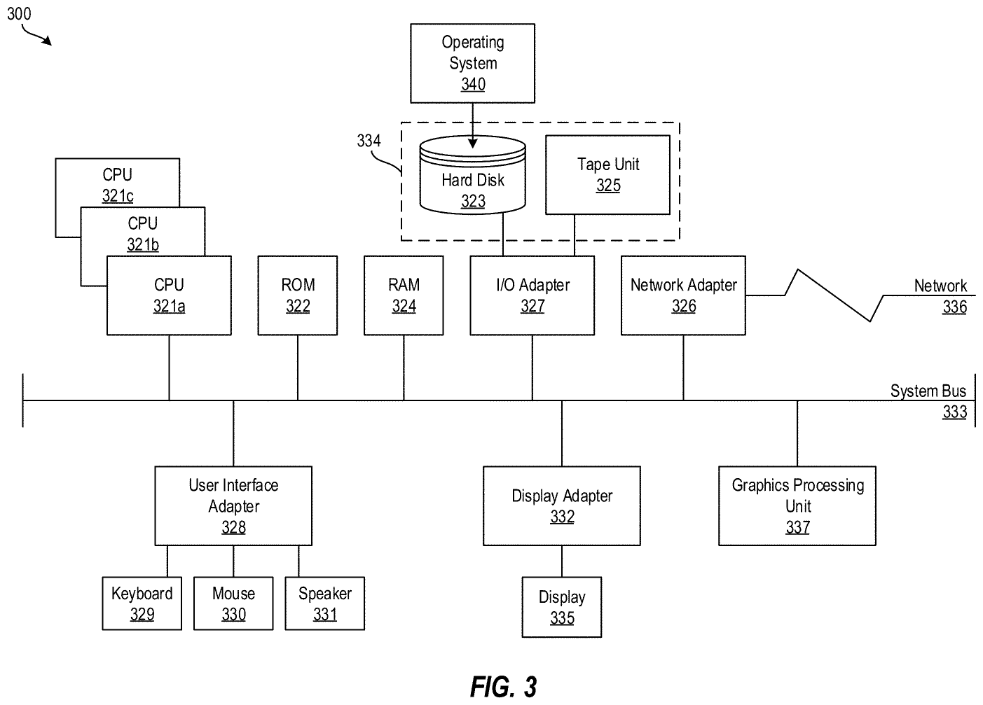

It is understood that the present disclosure is capable of being implemented in conjunction with any other type of computing environment now known or later developed. For example, FIG. 3 depicts a block diagram of a processing system 300 for implementing the techniques described herein. In examples, processing system 300 has one or more central processing units (processors) 321a, 321b, 321c, etc. (collectively or generically referred to as processor(s) 321 and/or as processing device(s)). In aspects of the present disclosure, each processor 321 can include a reduced instruction set computer (RISC) microprocessor. Processors 321 are coupled to system memory (e.g., random access memory (RAM) 324) and various other components via a system bus 333. Read only memory (ROM) 322 is coupled to system bus 333 and may include a basic input/output system (BIOS), which controls certain basic functions of processing system 300.

Further depicted are an input/output (I/O) adapter 327 and a network adapter 326 coupled to system bus 333. I/O adapter 327 may be a small computer system interface (SCSI) adapter that communicates with a hard disk 323 and/or a tape storage drive 325 or any other similar component. I/O adapter 327, hard disk 323, and tape storage device 325 are collectively referred to herein as mass storage 334. Operating system 340 for execution on processing system 300 may be stored in mass storage 334. The network adapter 326 interconnects system bus 333 with an outside network 336 enabling processing system 300 to communicate with other such systems.

A display (e.g., a display monitor) 335 is connected to system bus 333 by display adapter 332, which may include a graphics adapter to improve the performance of graphics intensive applications and a video controller. In one aspect of the present disclosure, adapters 326, 327, and/or 332 may be connected to one or more I/O busses that are connected to system bus 333 via an intermediate bus bridge (not shown). Suitable I/O buses for connecting peripheral devices such as hard disk controllers, network adapters, and graphics adapters typically include common protocols, such as the Peripheral Component Interconnect (PCI). Additional input/output devices are shown as connected to system bus 333 via user interface adapter 328 and display adapter 332. A keyboard 329, mouse 330, and speaker 331 may be interconnected to system bus 333 via user interface adapter 328, which may include, for example, a Super I/O chip integrating multiple device adapters into a single integrated circuit.

In some aspects of the present disclosure, processing system 300 includes a graphics processing unit 337. Graphics processing unit 337 is a specialized electronic circuit designed to manipulate and alter memory to accelerate the creation of images in a frame buffer intended for output to a display. In general, graphics processing unit 337 is very efficient at manipulating computer graphics and image processing, and has a highly parallel structure that makes it more effective than general-purpose CPUs for algorithms where processing of large blocks of data is done in parallel.

Thus, as configured herein, processing system 300 includes processing capability in the form of processors 321, storage capability including system memory (e.g., RAM 324), and mass storage 334, input means such as keyboard 329 and mouse 330, and output capability including speaker 331 and display 335. In some aspects of the present disclosure, a portion of system memory (e.g., RAM 324) and mass storage 334 collectively store an operating system such as the AIX® operating system from IBM Corporation to coordinate the functions of the various components shown in processing system 300.

Turning now to an overview of technologies that are more specifically relevant to embodiments of the invention, the present techniques reduce overlap among a collection of digital photographs (also referred to as “images”). When multiple users take photographs and share the photographs of a joint event (e.g., a group vacation, a group trip, etc.), some of the shared photographs may be duplicates or similar. For example, both a first user and a second user take a photograph of the same group of people standing in front of a structure. Consequently, when the two users share photographs from the event, two similar photographs exist. These similar photographs are referred to as overlapping images (or an “overlap”).

As another example, friends and family go on vacation together and people end up taking multiple photographs that are similar to the same people and/or scene. With the digital photographs, people end up taking hundreds of photographs of one trip. The significant number of photographs may require an extensive amount of time to view and organize. This gets even more convoluted when the family or friends share their photographs with one another. For example, each person has their own photographs but also the photographs that others captured. This may result in a very large number of photographs, many of which may be similar. In some cases, a user may have multiple camera devices (e.g., a smartphone with a camera and digital camera). The user may take similar photographs with each device, resulting in the user having multiple similar images.

Turning now to an overview of the aspects of the invention, one or more embodiments of the invention address the above-described shortcomings of the prior art by reducing overlap among a collection of photographs. This reduces the number of similar photographs that result from multiple devices taking photographs of a similar event, artifacts, people, scenes, etc. The present techniques also improve a user's experience when using a processing system to view the photographs by reducing the number of images shown, creating virtual containers to store and display similar photographs, and removing extra of similar photographs. In examples, the present techniques remove one or more of the similar photographs (e.g., remove all but one similar photograph). This particularly improves computer functionality by removing (e.g., deleting) similar photographs, thereby saving storage space in a memory or other storage device.

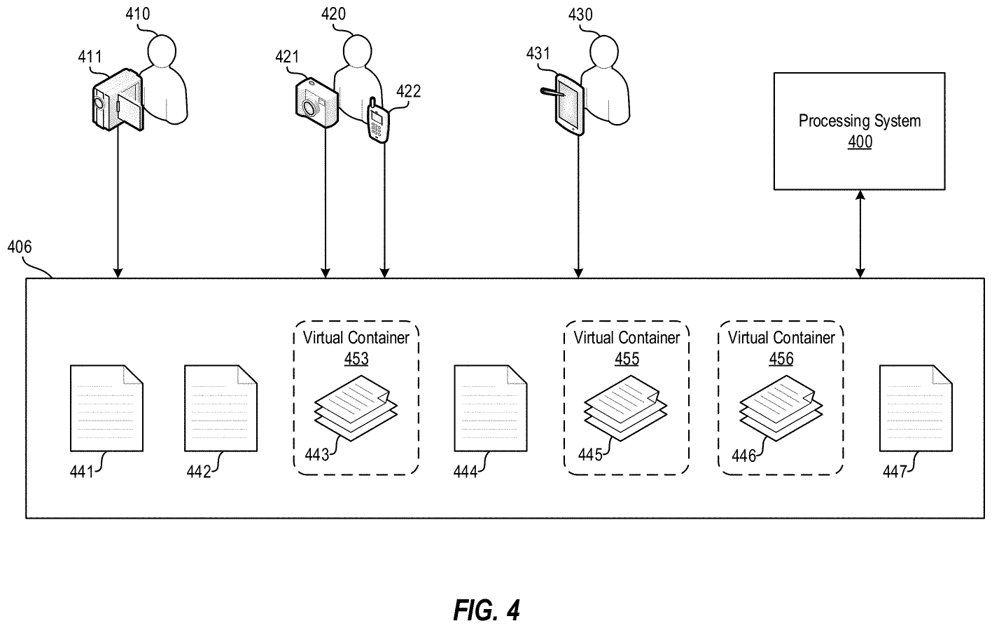

Turning now to a more detailed description of aspects of the present invention, FIG. 4 depicts a block diagram of a processing system 400 for reducing overlap among a collection of images according to one or more embodiments described herein.

Friends (e.g., users 410, 420, 430) go on a trip or vacation together. Each user 410, 420, 430 can have a camera and/or a user device equipped with a camera. For example, a user device 411 is associated with the user 410, user devices 421, 422 are associated with the user 420, and a user device 431 is associated with the user 430. The user devices 411, 421, 422, 431 can be configured with a camera(s) to capture images. For example, the user device 411 is a video camera, the user device 421 is a digital camera, the user device 422 is a mobile phone or smartphone, and the user device 431 is a mobile computing device such a tablet computer. It should be appreciated that other types and numbers of user devices can be used in accordance with the techniques described herein.

Throughout the trip, each user 410, 420, 430 takes photographs using the user devices 411, 421, 422, 431. The photographs can be shared among the users 410, 420, 430. For example, the images can be shared immediately (e.g., an image is captured and uploaded to a data store 406 as soon as it is captured) or can be shared at a later time. The processing system 400 analyzes each of the images uploaded to the data store 406 (or received directly from the user devices 411, 421, 422, 431) to identify when two (or more) of the images are similar or the same. This occurs regardless of which user or user device took the photograph since they are shared.

In some examples, the user devices 411, 421, 422, 431 transmit image data directly to the data store 406. However, in other examples, the user devices transmit image data directly to the data engine 510 of the processing system 400. Accordingly, the data engine 510 can receive data from the user devices 411, 421, 422, 431 and/or from the data store 406.

The data store 406 stores a collection of images, including, for example, images 441, 442, 443, 444, 445, 446, 447. The image 443 represents a group of images that are identified by the processing device 400 as being similar and are stored in a virtual container 453 that is created by the processing device 400. Similarly, the images 445 and 446 each represent a group of similar images that are stored in virtual containers 455 and 456 respectively. A virtual container is a stack, folder, or another mechanism for grouping images, such as images that are similar or the same.

The virtual containers 453, 455, 456 can display a representative image, which can be selected based on which user (e.g., the users 410, 420, 430) is viewing the virtual container, for example. The processing system 400 considers preferences of the users 410, 420, 430, where available, to select the representative image that is representative of similar photographs. For example, the processing system 400 can analyze photographs based on preferences like resolution, aspect ratio, photobombs, eyes open, etc. In one example, a photograph is selected as being a representative image for the user 410 based on a preference of the user 410 to have the highest resolution photographs available, while another photograph is elected as being a representative image for the user 420 based on a user preference of the user 420 that a particular subject (e.g., a spouse or child of the user 420) does not have his/her eyes closed. The virtual containers 453, 455, 456 can be based on each of the users' preferences. According to one or more embodiments described herein, the rest of the images that are similar are organized in the virtual container in case the user wants to view these similar images. However, in other examples, the rest of the images that are similar are automatically deleted. This improves the processing system 400 by reducing the amount of data required to be processed and stored in the data store 406.

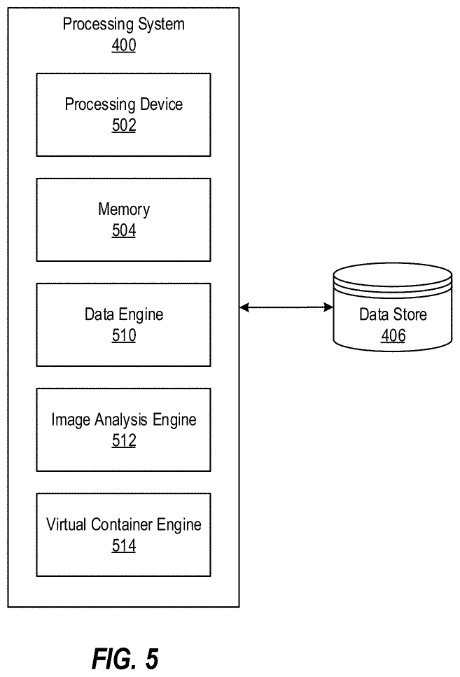

FIG. 5 depicts a block diagram of the processing system 400 for reducing overlap among a collection of images according to one or more embodiments described herein. The processing system 400 includes a processing device 502, a memory 504, a data engine 510, an image analysis engine 512, and a virtual container engine 514. The processing system 400 is communicatively coupled to the data store 406, which stores data such as images.

The various components, modules, engines, etc. described regarding FIG. 5 can be implemented as instructions stored on a computer-readable storage medium, as hardware modules, as special-purpose hardware (e.g., application specific hardware, application specific integrated circuits (ASICs), application specific special processors (ASSPs), field programmable gate arrays (FPGAs), as embedded controllers, hardwired circuitry, etc.), or as some combination or combinations of these. According to aspects of the present disclosure, the engine(s) described herein can be a combination of hardware and programming. The programming can be processor executable instructions stored on a tangible memory, and the hardware can include the processing device 502 for executing those instructions. Thus a system memory (e.g., the memory 504) can store program instructions that when executed by the processing device 502 implement the engines described herein. Other engines can also be utilized to include other features and functionality described in other examples herein.

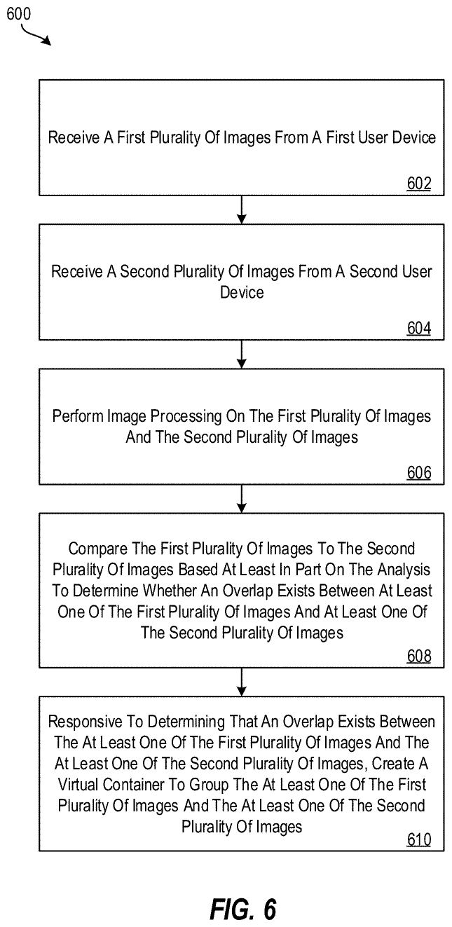

The features and functionality of the components, modules, engines, etc. depicted in FIGS. 4 and 5 are described in more detail with reference to FIG. 6. In particular, FIG. 6 depicts a flow diagram of a method 600 for reducing overlap among a collection of images according to one or more embodiments described herein. The method 600 can be performed by any suitable processing system (e.g., the cloud computing environment 50, the processing system 300, the processing system 400, etc.) and/or any suitable processing device (e.g., the processing device 321, the processing device 502, etc.).

At block 602, the data engine 510 receives one or more images from a first user device. The user device can be any suitable processing system and/or processing device, such as user devices 411, 421, 422, 431 depicted in FIG. 4. The images can also be stored in and received from a data store, such as the data store 406. At block 604, the data engine 510 receives a second plurality of images from a second user device (e.g., another of the user devices 411, 421, 422, 431). The images can also be stored in and received from a data store, such as the data store 406. In some examples, the first and second user devices are associated with the same user; in other examples, the first user device is associated with a first user, and the second user device is associated with a second user.

At block 606, the image analysis engine 512 performs image processing on the first plurality of images and the second plurality of images. According to one or more embodiments described herein, the image processing performs feature extraction, facial recognition, and/or classification on the images. Performing image processing can utilize geolocation information (i.e., where an image was taken), facial recognition information (i.e., who is an image), content information (i.e., what is in an image), social networking relationship information (e.g., whether a relationship exists between the users who captured the image, whether a relationship exists between people in an image, whether a relationship exists between a person in an image and a user capturing the image, etc.), or timestamp information (i.e., when the image was captured). For example, the image analysis engine 512 can determine that two particular subjects—Subject A and Subject B—are in multiple images using facial recognition image processing. It can then be determined that, for example, that Subject A and Subject B are connections on a social media platform. Further, the image analysis engine 512 can determine, using location and timestamp information, that the images containing Subject A and Subject B were taken at approximately the same time (e.g., within a few seconds or minutes of each other) at approximately the same location (e.g., in front of the same landmark, at the same GPS coordinates, etc.). This information can be used to determine that the images are similar as described with reference to block 608.

In particular, at block 608, the image analysis engine 512 uses the results of the image analysis to compare images to determine similar images. For example, the image analysis engine 512 compares the first plurality of images to the second plurality of images based at least in part on the analysis to determine whether an overlap exists between at least one of the first plurality of images and at least one of the second plurality of images. Overlap exists when two images are considered similar. For example, the image analysis engine 512 can compute a similarity score between the two images to quantify a degree of similarity between two images. If the similarity score is above a threshold (e.g., above 90% similar), the images are considered similar and thus an overlap exists. It should be appreciated that other image comparisons can be used instead of, or in addition to, similarity scores and that the threshold can vary based on types of images, user preferences, and/or other factors.

At block 610, when it is determined that an overlap exists between the at least one of the first plurality of images and the at least one of the second plurality of images, the virtual container engine 514 creates a virtual container to group the at least one of the first plurality of images and the at least one of the second plurality of images.

Additional processes also may be included. For example, the method 600 can include automatically deleting at least one image of the at least one of the first plurality of images or the at least one of the second plurality of images responsive to determining that an overlap exists between the at least one of the first plurality of images and the at least one of the second plurality of images. Other images of the at least one of the first plurality of images and the at least one of the second plurality of images can be retained. It should be understood that the process depicted in FIG. 6 represents an illustration, and that other processes may be added or existing processes may be removed, modified, or rearranged without departing from the scope and spirit of the present disclosure.

In another embodiment, photographs taken by other users are shared immediately. The shared phones can be available to another user at the time when the user is taking a photograph. For example, when the user opens the camera application, he can be notified about other photographs that are available. The notification and selection of the virtual container of photograph can based on criteria similar to the criteria used by the data engine 510 to identify similar photographs. For example, the current view of the camera is at a specific time, a specific GPS location, pointing at a specific direction, with specific faces in the view. The GPS location of the faces to be captured can first be determined. The image analysis engine 512 can use time and GPS location of the faces to search for matching photographs captured by other users. Next, the selected photographs can be filtered, by the image analysis engine 512, by removing photographs with a different number of faces. Then, the faces in the filtered photographs are compared, by the image analysis engine 512, with the one or more photographs from the virtual container. This process allows multiple steps to narrow down the set of photographs taken by other users by initially using the criteria that uses the least amount of computing resources or requires the least amount of network transmission, and can be computed in shortest time. Once one or more virtual containers are identified as matching the current view of the camera, the user will be notified of any existing photographs. Furthermore, one or a list of virtual containers, or photographs within the virtual container, can be selected based on a “preference score,” which ranks the photograph or virtual container on the similarity with the current view of camera, and other criteria for “good” photographs including eyes open, smiling etc. Rather than being based on a photograph to photograph comparison, the matching score is based on objects and characteristic of those objects in the photograph. For example, the similarity score can be based on similar people in the photograph, and identified expressions such as formal smile, funny expression etc. as a criteria for matching with the view of the camera. By not performing photograph to photograph comparison, it allows identifying similar photographs by theme. Furthermore, the “good” photograph criteria can also be based on the theme. For example, if a view shows that everyone in a photograph has funny face, it will try to look for photographs from other users that has maximum number of people in the photograph that has funny faces. Then, the one or sorted list of photographs or virtual containers can be displayed to the user. The user has the option to take a photograph using the camera, select one of the photographs taken by other users as the preferred photograph, and/or keep a link to the virtual container such that a preferred photograph can be selected at a later time.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instruction by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments described herein.

What is claimed is:

1. A computer-implemented method comprising:
receiving, by a processing device, a first plurality of images from a first user device;
receiving, by the processing device, a second plurality of images from a second user device;
performing, by the processing device, image processing on the first plurality of images and the second plurality of images;
comparing, by the processing device, the first plurality of images to the second plurality of images based at least in part on the image processing to determine whether an overlap exists between at least one of the first plurality of images and at least one of the second plurality of images; and
responsive to determining that an overlap exists between the at least one of the first plurality of images and the at least one of the second plurality of images, creating, by the processing device, a virtual container to group the at least one of the first plurality of images and the at least one of the second plurality of images.

2. The computer-implemented method of claim 1, further comprising:
responsive to determining that an overlap exists between the at least one of the first plurality of images and the at least one of the second plurality of images, automatically deleting at least one image of the at least one of the first plurality of images or the at least one of the second plurality of images.

3. The computer-implemented method of claim 2, further comprising:
retaining other images of the at least one of the first plurality of images and the at least one of the second plurality of images.

4. The computer-implemented method of claim 1, wherein the first user device is associated with a first user, and wherein the second user device is associated with a second user.

5. The computer-implemented method of claim 1, wherein the first user device is associated with a first user, and wherein the second user device is associated with the first user.

6. The computer-implemented method of claim 1, wherein performing image processing utilizes at least one of geolocation information, facial recognition information, content information, social networking relationship information, and timestamp information.

7. The computer-implemented method of claim 1, wherein one of the at least one of the first plurality of images or one of the at least one of the second plurality of images is designated as a representative image for the virtual container.

8. The computer-implemented method of claim 1, wherein the comparing is based at least in part on computing a similarity score between the at least one of the first plurality of images and the at least one of the second plurality of images.

9. The computer-implemented method of claim 8, wherein the overlap is determined to exist between the at least one of the first plurality of images and the at least one of the second plurality of images when the similarity score exceeds a threshold.

10. The computer-implemented method of claim 1, further comprising:
responsive to determining that an overlap exists between the at least one of the first plurality of images and the at least one of the second plurality of images, performing real time sharing of at least one image of the at least one of the first plurality of images or the at least one of the second plurality of images between a first user and a second user.

11. A system comprising:
a memory comprising computer readable instructions; and
a processing device for executing the computer readable instructions for performing a method comprising:
receiving, by the processing device, a first plurality of images from a first user device;
receiving, by the processing device, a second plurality of images from a second user device;
performing, by the processing device, image processing on the first plurality of images and the second plurality of images;
comparing, by the processing device, the first plurality of images to the second plurality of images based at least in part on the image processing to determine whether an overlap exists between at least one of the first plurality of images and at least one of the second plurality of images; and
responsive to determining that an overlap exists between the at least one of the first plurality of images and the at least one of the second plurality of images, creating, by the processing device, a virtual container to group the at least one of the first plurality of images and the at least one of the second plurality of images.

12. The system of claim 11, wherein the method further comprises:
responsive to determining that an overlap exists between the at least one of the first plurality of images and the at least one of the second plurality of images, automatically deleting at least one image of the at least one of the first plurality of images or the at least one of the second plurality of images.

13. The system of claim 12, wherein the method further comprises:
retaining other images of the at least one of the first plurality of images and the at least one of the second plurality of images.

14. The system of claim 11, wherein the first user device is associated with a first user, and wherein the second user device is associated with a second user.

15. The system of claim 11, wherein the first user device is associated with a first user, and wherein the second user device is associated with the first user.

16. The system of claim 11, wherein performing image processing utilizes at least one of geolocation information, facial recognition information, content information, social networking relationship information, and timestamp information.

17. The system of claim 11, wherein one of the at least one of the first plurality of images or one of the at least one of the second plurality of images is designated as a representative image for the virtual container.

18. The system of claim 11, wherein the comparing is based at least in part on computing a similarity score between the at least one of the first plurality of images and the at least one of the second plurality of images, and wherein the overlap is determined to exist between the at least one of the first plurality of images and the at least one of the second plurality of images when the similarity score exceeds a threshold.

19. The system of claim 11, wherein the method further comprises:
responsive to determining that an overlap exists between the at least one of the first plurality of images and the at least one of the second plurality of images, performing real time sharing of at least one image of the at least one of the first plurality of images or the at least one of the second plurality of images between a first user and a second user.

20. A computer program product comprising:
a computer readable storage medium having program instructions embodied therewith, the program instructions executable by a processing device to cause the processing device to perform a method comprising:
receiving, by the processing device, a first plurality of images from a first user device;
receiving, by the processing device, a second plurality of images from a second user device;
performing, by the processing device, image processing on the first plurality of images and the second plurality of images;
comparing, by the processing device, the first plurality of images to the second plurality of images based at least in part on the image processing to determine whether an overlap exists between at least one of the first plurality of images and at least one of the second plurality of images; and
responsive to determining that an overlap exists between the at least one of the first plurality of images and the at least one of the second plurality of images, creating, by the processing device, a virtual container to group the at least one of the first plurality of images and the at least one of the second plurality of images.
